(19) United States
(12) Patent Application Publication
(10) Pub. No.: US 2025/0236089 A1
(43) Pub. Date: Jul. 24, 2025

(54) COMPOSITE COMPONENT AND METHOD FOR PRODUCING SAME

(71) Applicant: SGL CARBON SE, Wiesbaden (DE)

(72) Inventors: Christoph EBEL, Meitingen (DE); Maximilian SCHAEFER, Meitingen (DE); Bernd WOHLETZ, Meitingen (DE); Juergen JOOS, Meitingen (DE); Christian SCHLUDI, Meitingen (DE)

(73) Assignee: SGL CARBON SE, Wiesbaden (DE)

(21) Appl. No.: 18/854,089

(22) PCT Filed: Mar. 27, 2023
(86) PCT No.: PCT/EP2023/057802

§ 371 Date: Oct. 4, 2024

(30) Foreign Application Priority Data
Apr. 6, 2022 (DE) 10 2022 203 415.5

(51) Int. Cl. B32B 7/02; B32B 27/18

(52) U.S. Cl. CPC B32B 7/02; B32B 27/18; B32B 2307/3065; B32B 2457/10

(57) ABSTRACT

A composite component, a motor vehicle component or a building component comprising the composite component, to a method for producing the composite component and to the use of the composite component.

### FIELD

The invention relates to a composite component, a motor vehicle component or a building component comprising the composite component, to a method for producing the composite component and to the use of the composite component.

### BACKGROUND

Composite components are already known from the prior art, with which different functionalities, such as a flame-retardant effect, can be realized in technical items.

US 2005/0170238 A1 discloses, for example, a battery housing which is formed from a flame-retardant polymer composition made of high-density polyethylene, which can comprise a glass fiber reinforcement and a fire-resistant additive. During production, the fire-resistant additive is mixed in the melt with the polyethylene to be protected and the mass is subsequently pressed into the desired shape. One of the disadvantages here is that the additive concentration is spatially evenly distributed and the concentration cannot be locally controlled/regulated.

US 2020/0152926 A1 describes a lid for a battery pack of an electric vehicle with a frame consisting of a layered composite. A first layer of the composite comprises a so-called “shear panel” which has a fiber-reinforced composite layer which is intended to counteract a shear deformation in the event of an impact. As a separate element, the layered composite comprises a fire- and abrasion-resistant second functional layer which is deposited on the shear panel and which faces the battery when the shear panel is connected to the frame of the vehicle.

However, such an arrangement has the disadvantage that the separate fire-resistant second layer is susceptible to breakage and ablation and can easily be separated from the layered composite, in particular under thermal stress, due to the strongly deviating material structure. As a rule, the functionality of the composite component, which is caused by the corresponding functional layer, cannot be ensured in the long term. In addition, such layered composites often require large amounts of additives, which can result in increased product costs.

Apart from the fact that methods for producing such layered composites are laborious and complex, the realization of complex geometries is not possible at all or only to a very limited extent. For example, to represent multidimensional components, it is necessary to cut flat blanks into pieces, which is associated with increased costs and limited component accuracy. To counteract these disadvantages, a great deal of effort is required in production and quality assurance.

In addition, due to the low structural integrity of such a layered composite, a thicker and/or heavier design is usually necessary in order to maintain a comparable level of functionality. Furthermore, typical joining methods such as gluing or coating often lead to an inadequate connection of the different portions, for example due to poor adhesion properties of the very different materials. Such components pose a risk in particular for automotive applications, as the corresponding layers can become loose and fall off during normal driving. In applications in battery housings, fire-retardant layers can detach from the surface to be protected when exposed to fire. Poor abrasive behavior is often observed in the case of particle bombardment when the battery cell is thermally overheated.

### SUMMARY

Against this background, the object of the present invention was therefore to provide a composite component with which the disadvantages of the prior art described above can be avoided, which in particular allows for improved and longer-term functionality of the composite component and which can be produced in a simple, cost-effective and process-reliable manner. In addition, improved control of the material properties should be possible.

This object is achieved according to the invention by a composite component which comprises or consists of the following components:
a) a fiber material,
b) a matrix material, and
c) a functional region with an additive arranged therein which causes or influences a material property, in particular an optical, thermal, mechanical and/or electromagnetic material property, in the functional region, wherein
the functional region has a concentration gradient of the additive, so that the material property caused or influenced by the additive is pronounced to a locally different degree in the functional region.

The composite component comprises one or more regions, wherein at least one of the regions is a functional region having an additive with a concentration gradient. The functional region thereby has a locally differently pronounced degree of functionality. Preferably, the functional region has matrix material and/or fiber material. In another preferred embodiment, the functional region does not have a fiber material.

The functional region can also comprise pores, i.e., air and/or gas inclusions, which, however, preferably do not constitute more than 5 vol. % of the total volume of the functional region.

The functional region can preferably form the entire composite component, i.e., the composite component has only one region—the functional region—of which the composite component consists. However, the composite component can also have further regions, in particular further functional regions.

The composite component preferably consists exclusively of regions which comprise both a fiber material and a matrix material.

For linguistic simplification, reference is made below to “a” fiber material and/or “a” region, and/or “a” functional region, and/or “a” matrix material and/or “an” additive and/or “a” concentration gradient. However, this is not to be understood as a numerical limitation. In the following, the use of the singular is always to be interpreted such that it can also be “one or more” of the corresponding component.

A “composite component” is understood to mean a material composed of two or more connected materials, such as a combination of a fiber material and a matrix material, which have different material properties than its individual components and which can serve as a component of a technical item. Such a component can be, for example, a plate or a housing of a machine. However, the term also comprises composite components which can form a technical item per se. The composite component according to the invention is a fiber composite material such as GRP or CFRP.

The composite component can have one or more regions, wherein at least one of the regions is a functional region. The functional region gives the composite component a functionality desired for an application purpose, e.g., shielding or fire protection, by providing or influencing specific material properties. For this purpose, the functional region comprises an additive and optionally a fiber material and/or optionally a matrix material or consists of the aforementioned components. In this context, the fiber material of the composite component is not an additive within the meaning of the present invention, i.e., the additive is an additive which is different from the fiber material and causes or influences a material property, in particular an optical, thermal, mechanical and/or electromagnetic material property, in the functional region.

The composite component can be produced by joining different workpieces or coating a workpiece. However, the composite component is preferably designed integrally, i.e., in one piece. The composite component is particularly preferably obtained during its production by integral curing. The functional region can be produced by joining different workpieces or coating a workpiece. However, the functional region is preferably designed integrally, i.e., in one piece. Particularly preferably, the functional region is obtained during its production by integral curing.

The volume fraction of the functional region relative to the total volume of the composite component is preferably ≥2 vol. %, more preferably ≥5 vol. %, still more preferably ≥10 vol. %, even considerably more preferably ≥20 vol. %, even significantly considerably more preferably ≥40 vol. %, and most preferably ≥60 vol. %.

Preferably, the matrix material of one, several or all regions of the composite component, with the exception of the incorporated additive and the incorporated fiber material, has a substantially homogeneous chemical composition, i.e., material boundaries, with the exception of the incorporated additive and the incorporated fiber material, are present not at all or only in adjacent regions of the composite component.

As already described, the additive is a component which is contained in the composite component in addition to the fiber material and to the matrix material and which causes or influences, in particular strengthens or weakens, a material property of the functional region, in particular an optical, thermal, mechanical and/or electromagnetic property. This means that one or more material properties of the functional region are newly developed, strengthened or reduced, compared to a functional region without the corresponding additive. The additive and/or the fiber material are at least partially, preferably substantially, embedded in the matrix material. In this context, substantially means that at least 70 vol. % of the fiber material is completely surrounded by matrix material, preferably at least 75 vol. %, more preferably at least 80 vol. %, still more preferably at least 85 vol. %, still more preferably at least 90 vol. %, and most preferably at least 95 vol. %. Very particularly preferably, the additive and/or the fiber material are completely embedded in the matrix material.

A functional region has a concentration gradient of the additive, so that it comprises disjoint volume elements (i.e., volume elements without a volume intersection) with a different concentration of the additive, and as a result the property caused or influenced by the additive is strongly pronounced in the functional region in a locally different manner. The volume of the disjoint volume elements is preferably ≥1%, more preferably ≥2%, still more preferably ≥5%, but preferably also ≤10% of the total volume of the functional region and/or of the composite component. A concentration gradient denotes a preferably continuous local change in the concentration of the additive within the functional region, preferably within the optional matrix material of the functional region. Continuously is understood to mean a continuous profile of the concentration function, i.e., the concentration values of the concentration gradient. The concentration gradient is preferably predefined, i.e., has a profile of the concentration values and/or direction predetermined by a method measure implemented during the production method. In the context of the invention, concentration is understood to mean the mass concentration, i.e., the mass of the additive per volume unit of the composite component (e.g., g/L).

The spatial dimensions of the regions of the composite component and of the composite component itself are not limited within the scope of the invention. The composite component can preferably be a plate, such as a fire protection panel. A region of the composite component can preferably be a layer. For this case, the composite component is particularly preferably a layered composite or has such a composite. A layer is understood to mean a preferably flat-surfaced mass of a material or a material mixture which preferably has a material boundary with the further regions of the composite component.

The term “material properties of the functional region” comprises all material properties of the material or of the material mixture which forms the functional region. The term includes both physical properties, such as thermal conductivity or expansion coefficient, and chemical material properties, such as combustibility or antimicrobial effect.

In a preferred embodiment of the invention, the material property which the additive causes in the functional region or which the additive influences is a physical material property, preferably an optical, thermal, mechanical, acoustic, electrodynamic, thermodynamic and/or electromagnetic property. Particularly preferably, the physical material property is selected from the group consisting of expansion coefficient, heat capacity, heat conduction/thermal conductivity, ductility, elasticity, strength, hardness, wear resistance, toughness, permeability, in particular magnetic permeability, absorption behavior, and emission behavior, reflection and transparency.

In a preferred embodiment of the invention, the material property which the additive causes in the functional region or which the additive influences is a chemical property. The chemical material property is preferably selected from the group consisting of antimicrobial effect, combustibility, corrosion resistance, solubility and acidity constant.

In a preferred embodiment of the invention, the material property which the additive causes in the functional region or which the additive influences is a physiological material property. The physiological material property is preferably selected from the group consisting of odor, taste and toxicity, in particular ecotoxicity.

“Fiber materials” are materials which have linear, thread-like structures or consist thereof, which in turn preferably are parts of a more complex surface structure such as a woven fabric, a nonwoven, a laid scrim, or a knitted fabric.

The matrix material of the composite component according to the invention serves for at least partially, preferably completely embedding the fiber material, and optionally also for at least partially, preferably completely embedding the additive and/or optionally for at least partially, preferably completely dissolving the additive. It holds the fibers of the fiber material in their position and transfers and distributes stresses between them. It is preferably a polymer material, in particular a thermosetting polymer material. It is preferably a polymer material produced from a resin and a curing agent. In the preparation, accelerators, activators and release agents are preferably used which are then preferably part of the matrix material within the meaning of the present invention.

By integrating an additive which causes or influences a material property, a composite component having structural integrity and high mechanical stability is obtained and simultaneously has a further functionality, such as flame-retardant activity, for example. By means of the concentration gradient, the spatial profile of the material properties can be adapted for the specific application of the composite component without thereby requiring a complex component structure which demands increased manufacturing effort. For example, flame-retardant additives can be aggregated within a subsection of the functional region, which subsection is particularly susceptible to fire or high thermal stress. Another example is the accumulation of metallic particles in a subsection of the functional region in order to thereby influence the electromagnetic properties of the composite component.

An integral character of the functional region with a further region is particularly preferred, particularly preferably with all further regions of the composite component, i.e., an integral design of the composite component.

The preferably integral nature of the composite component with fiber material and additive avoids breakage, detachment or separation of regions, in particular layers, with different functions, which occurs particularly frequently in 3D geometries especially and with very thin layers. Difficulties associated with the different thermal expansion of individual layers can also be avoided. The avoidance of connecting elements (e.g., adhesives or rivets) also results in a simple and stable construction.

In contrast to the composite known from the prior art consisting of a composite layer and an additional functional layer, the functional region according to the invention can also be manufactured in a one-step process without subsequent joining or coating. This not only saves manufacturing costs, but also significantly simplifies component qualification. In addition, the targeted control of additive addition can also reduce the total amount of additives required, which is particularly advantageous from both an economic and ecological perspective.

The composite component preferably consists of a functional region according to the invention. In another preferred embodiment of the invention, however, the composite component has further regions, in particular further functional regions. For example, the composite component can have two or more functional regions according to the invention with different additives.

In a preferred embodiment of the invention, the composite component has a sandwich structure with several layers, wherein preferably at least one, more preferably all of the outermost layers are functional regions according to the invention or the layers as a whole form a functional region. This means that in the latter case the functional region is formed by several layers, each of which preferably has substantially spatially constant concentrations of the additive and is preferably each designed integrally. A functional region formed by one or more layers can be connected to the rest of the composite component by positive locking or material bonding.

In addition, integral and multi-layer designs can also be linked together, for example by combining an integral functional region formed by a layer having a concentration gradient with a functional region formed by several layers of different concentrations.

Preferably, all regions of the composite component have the identical matrix material. This results in composite components that are mechanically particularly stable.

In a preferred embodiment, the volume ratio of matrix material to fiber material in the composite component is 8:1 to 1:10, preferably 5:1 to 1:8, and particularly preferably 2:1 to 1:5.

In a preferred embodiment, the weight ratio of matrix material to fiber material in the composite component is 5:1 to 1:20, preferably 3:1 to 1:10, and particularly preferably 1:1 to 1:8.

In a preferred embodiment, the volume ratio of matrix material to additive in the composite component is 100:1 to 1:5, preferably 50:1 to 1:3, and particularly preferably 2:1 to 1:2.

In a preferred embodiment, the weight ratio of matrix material to additive in the composite component is 100:1 to 1:10, preferably 50:1 to 1:6, and particularly preferably 4:1 to 1:4.

In a preferred embodiment, the proportion by weight of fiber material in the total mass of the composite component is from 10 to 95 wt. %, preferably 20 to 90 wt. %, more preferably 30 to 85 wt. %, still more preferably 40 to 80 wt. %, and most preferably 50 to 75 wt. %.

In a preferred embodiment, the proportion by weight of additive in the total mass of the composite component is 0.05 to 50 wt. %, preferably 0.1 to 25 wt. %, more preferably 0.3 to 15 wt. %, still more preferably 1.0 to 10 wt. %, and most preferably 2.0 to 5 wt. %.

In a preferred embodiment, the volume ratio of matrix material to fiber material in the functional region is 8:1 to 1:15, preferably 2:1 to 1:10 and particularly preferably 1:1 to 1:10.

In a preferred embodiment, the weight ratio of matrix material to fiber material in the functional region is 5:1 to 1:30, preferably 2:1 to 1:20, and particularly preferably 1:1 to 1:15.

In a preferred embodiment, the volume ratio of matrix material to additive in the functional region is 100:1 to 1:20, preferably 50:1 to 1:6 and particularly preferably 2:1 to 1:4.

In a preferred embodiment, the weight ratio of matrix material to additive in the functional region is 100:1 to 1:20, preferably 50:1 to 1:12 and particularly preferably 4:1 to 1:8.

In a preferred embodiment, the proportion by weight of optionally contained fiber material in the total mass of the functional region is 20 to 80 wt. %, preferably 25 to 70 wt. %, more preferably 35 to 65 wt. %, still more preferably 30 to 60 wt. %, and most preferably 30 to 55 wt. %.

In a preferred embodiment, the proportion by weight of additive in the total mass of the functional region is 0.1 to 40 wt. %, preferably 0.2 to 30 wt. %, more preferably 0.5 to 20 wt. %, still more preferably 1.0 to 10 wt. %, and most preferably 1.0 to 5 wt. %.

The proportions of resin, fiber and pores are preferably determined as described in ISO 14127, first edition, 2008.

A concentration gradient consists of a plurality of points. The “points” of the concentration gradient represent concentration values of the additive in the disjoint volume elements of the functional region, i.e., a point which is arranged centrally in the volume element is assigned the corresponding concentration value of the volume element. By connecting the points at different concentrations, the spatial profile of the concentration gradient and thus its length Lₖ can then be determined and set, for example, in relation to the component extension.

A volume element associated with a point of the concentration gradient is preferably obtained and defined in such a way that a portion of the volume of the composite component (e.g., functional region), preferably the entire volume of the composite component, is divided into volume elements of equal volume (i.e., volume deviations ≤5%, preferably ≤2%), and the concentration of the additive in the individual volume elements is determined. Corresponding methods for analyzing the additive content of different additives are known to a person skilled in the art and described in detail in conventional manuals such as, for example, in the Taschenbuch der Kunststoff-Additive [Handbook of Plastic Additives], 3rd edition, Gächter, Müller, Carl Hanser Verlag, 1989, chapter 20. An analysis can take place, for example, by incinerating and/or dissolving components, as explained in ISO 14127, first edition, 2008. The concentration value associated with the point of the concentration gradient can thereby be determined. By comparing the concentration values of the additive for the different disjoint volume elements, such as, for example, layers or cubes, it can then be determined whether a concentration difference is present, i.e., a concentration gradient having two or more points is present. The points with which corresponding concentration values are associated and which thus represent the concentrations in the volume elements are each arranged in the volume centroid of the volume elements. The concentration gradient of the length Lₖ is obtained by connecting the points of different concentration. The points are preferably connected always from one point to the spatially closest, i.e., over the shortest route. The volume of one of the disjoint volume elements is preferably ≥ 1/50 of the total volume of the composite component V_{KB}, still more preferably ≥ 1/20*V_{KB}, still more preferably ≥ 1/10*V_{KB}, but preferably also ≤⅕*V_{KB}. In order to enable a simple and practicable analysis, the composite component can preferably be divided into not more than 200, preferably not more than 100, more preferably not more than 50, even considerably more preferably not more than 10 volume elements of the same volume, and the concentration can be determined from these. The concentration gradient is preferably designed such that the concentration difference of two points which are arranged in succession along the length of the concentration gradient and represent different volume elements is ≥5%, more preferably ≥10%, still more preferably ≥15%, even considerably more preferably ≥20%, based on the higher concentration value in each case. This preferably applies to all adjacent concentration points of a concentration gradient. The concentration gradient preferably has only points with a concentration of the additive >0 and/or the functional region comprises only volume elements which have additive.

Preferably, the concentration value of the volume element having the highest concentration divided by the concentration value of the volume element having the smallest concentration is ≥2, preferably ≥5, still more preferably ≥10, even considerably more preferably ≥20 and most preferably ≥30 and/or the point spacing thereof is ≥0.01*B_{E}, preferably ≥0.05*B_{E}.

In a further preferred embodiment, a volume element, which is represented by one point, is obtained and defined by a layer of a thickness D, which is in each case removed from the composite component by milling, for example, and the concentration thereof is subsequently determined. The volumes of the removed layers are substantially the same (i.e., volume deviations ≤5%, preferably ≤2%). By comparing the concentrations of the additive for the different removed layers, i.e., the disjoint volume elements, it can then be determined whether a concentration difference is present, i.e., a concentration gradient is present. The thickness D of a measured layer is preferably ≤⅓ of the concentration gradient length, more preferably ≤⅕, still more preferably ≤ 1/10, and most preferably ≤ 1/20, but D≥ 1/100 of the concentration gradient length is also preferred. The volume of a layer is preferably ≥ 1/50 of the total volume of the composite component V_{KB}, still more preferably ≥ 1/20*V_{KB}, still more preferably ≥ 1/10*V_{KB}, but preferably also ≤⅕*V_{KB}. The layer density is preferably ≥0.05 mm, more preferably ≥0.1 mm, more preferably ≥3 mm, even more preferably ≥5 mm, but preferably also ≤5 cm. Preferably, the layer density D≥0.0001*B_{E}, preferably D≥0.0004*B_{E}, more preferably D≥0.0006*B_{E}, more preferably D≥0.0008*B_{E}, still more preferably D≥0.001*B_{E}, even considerably more preferably D≥0.005*B_{E}, and most preferably D≥0.01*B_{E}; however, D≤0.01*B_{E} is also preferred.

The concentration gradient is preferably designed such that the concentration difference of two points which are arranged in succession along the length of the concentration gradient and represent different volume elements is ≥5%, more preferably ≥10%, still more preferably ≥15%, even considerably more preferably ≥20%, based on the higher concentration value in each case. This preferably applies to all adjacent concentration points of a concentration gradient.

A concentration gradient may, for example, be formed from 10 concentration values, which represent the concentration of 10 removed layers having a thickness of the corresponding layer of 1 mm, wherein the corresponding points, which represent a concentration in the corresponding layer, always have a concentration difference of at least 20%. The above-described layer-by-layer removal for determining the concentration gradient is particularly suitable in the case of plate-shaped composite components, such as fire protection panels.

Particularly in the case of complex structures or if the functional region is small in relation to the composite component, the gradient can also be obtained and defined by cube-shaped elements being cut out of the composite component, the edge length of which is preferably ≤⅓ of the concentration gradient length, more preferably ≤⅕, still more preferably ≤ 1/10 and most preferably ≤ 1/20, but the edge length is preferably also ≥ 1/100 of the concentration gradient length. The volumes of the cubes are substantially equal (i.e., volume deviations ≤5%, preferably ≤2%). The volume of a cube is preferably ≥ 1/50 of the total volume of the composite component V_{KB}, still more preferably ≥ 1/20*V_{KB}, still more preferably ≥ 1/10*V_{KB}, but preferably also ≤⅕*V_{KB}. The edge length of the corresponding cube is preferably ≥0.5 mm, more preferably ≥1 mm, more preferably ≥3 mm, even more preferably ≥5 mm, but preferably also ≤5 cm. Preferably, the edge length of the cube is ≥0.0001*B_{E}, preferably ≥0.0004*B_{E}, more preferably ≥0.0006*B_{E}, more preferably ≥0.0008*B_{E}, still more preferably ≥0.001*B_{E}, even considerably more preferably ≥0.005*B_{E}, and most preferably ≥0.01*B_{E}; however, the edge length is preferably also ≤0.01*B_{E}. A concentration gradient can be formed, for example, from 10 concentration values which represent the concentration of 10 cut out cubes having an edge length of 1 mm, wherein the corresponding points arranged in the middle of the cube which represent a concentration in the corresponding cube, always have a concentration difference of at least 20%.

The concentration gradient is preferably designed such that the concentration difference of two points which are arranged in succession along the length of the concentration gradient and represent different volume elements is ≥5%, more preferably ≥10%, still more preferably ≥15%, even considerably more preferably ≥20%, based on the higher concentration value in each case. This preferably applies to all adjacent concentration points of a concentration gradient.

In a preferred embodiment of the invention, the concentration values of the concentration gradient increase or fall along its spatial profile, i.e., its length Lₖ, at least partially, preferably completely, continuously. In a preferred embodiment of the invention, the concentration gradient has a continuous profile of the concentration values over more than 10%, preferably more than 20%, still more preferably more than 40%, even more preferably more than 60%, and most preferably more than 75% of its length L_{K}. Due to a continuous profile of the concentration values of the concentration gradient, segregation effects and predetermined breaking points within the functional region are avoided, and the strength and resistance of the material are thereby increased.

In a preferred embodiment, the concentration gradient has a monotonically increasing profile of the concentration values over its length L_{K} at least partially, preferably completely, i.e., each measurement point has a higher concentration than the preceding one. In another preferred embodiment, the concentration gradient has a monotonically decreasing profile over its length L_{K} at least partially, preferably completely, i.e., each measurement point has a lower concentration than the preceding one.

The concentration gradient has over its length L_{K} a profile of the concentration values which, at least partially, preferably completely, is selected from the group consisting of linearly increasing, stepwise increasing, stepwise decreasing, non-linearly increasing, linearly decreasing, exponentially decreasing, exponentially increasing, and non-linearly decreasing.

In a preferred embodiment of the invention, the composite component has a maximum component extension B_{E}, which is defined by the maximum distance between two points of the component, and the concentration gradient has a length L_{K}, where L_{K}≥0.05*B_{E}, preferably L_{K}≥0.2*B_{E}, more preferably L_{K}≥0.3*B_{E}, more preferably L_{K}≥0.4*B_{E}, still more preferably L_{K}≥0.6*B_{E} and most preferably L_{K}≥0.75*B_{E}.

In a preferred embodiment of the invention, the functional region has a maximum functional region extension FB_{E}, which is defined by the maximum distance between two points of the functional region, and the concentration gradient has a length L_{K}, where L_{K}≥0.05*FB_{E}, preferably L_{K}≥0.2*FB_{E}, more preferably L_{K}≥0.3*FB_{E}, more preferably L_{K}≥0.4*FB_{E}, still more preferably L_{K}≥0.6*FB_{E} and most preferably L_{K}≥0.75*FB_{E}.

As a result of the most extensive possible extension of the preferably continuous concentration gradients, the most uniform possible transition between the zones of different concentrations of the additive is achieved. The composite component therefore has an increased structural integrity and strength.

The composite component is preferably a plate, such as a fire protection panel. For this case, the concentration gradient preferably runs along the height H_{B} of the plate. Preferably, the concentration gradient, in particular for this case, has a length L_{K} where L_{K}≥0.05*H_{B}, preferably L_{K}≥0.2*H_{B}, more preferably L_{K}≥0.3*H_{B}, more preferably L_{K}≥0.4*H_{B}, still more preferably L_{K}≥0.6*H_{B}, and most preferably L_{K}≥0.75*H_{B}. In other preferred embodiments, the concentration gradient runs along the length L_{B} of the plate. Preferably, the concentration gradient, in particular for this case, has a length L_{K} where L_{K}≥0.001*L_{B}, preferably L_{K}≥0.004*L_{B}, more preferably L_{K}≥0.006*L_{B}, more preferably L_{K}≥0.008*L_{B}, still more preferably L_{K}≥0.012*L_{B}, and most preferably L_{K}≥0.015*L_{B}. In other exemplary embodiments, the concentration gradient runs along the width B_{B} of the plate. Preferably, the concentration gradient, in particular for this case, has a length L_{K}, where L_{K}≥0.001*B_{B}, preferably L_{K}≥0.004*B_{B}, more preferably L_{K}≥0.006*B_{B}, more preferably L_{K}≥0.008*B_{B}, still more preferably L_{K}≥0.01*B_{B} and most preferably L_{K}≥0.012*B_{B}. In the above embodiments, the concentration gradient preferably has only points with a concentration of the additive >0, i.e., the profile of the concentration values is completely different from zero along the spatial profile of the gradient, and/or the functional region and optionally the composite component are designed in one piece, preferably cured in one piece. Also possible and preferred are combinations of the above preferred embodiments in which the concentration gradient has in each case a component along 2 or 3 of the plate axes (length, width, height).

The concentration gradient preferably has at least three points with different concentration values, preferably at least five points, still more preferably at least ten points, still more preferably at least 20 points, and most preferably at least 50 points, wherein these points are preferably uniformly spaced apart. The concentration gradient is then preferably designed such that the concentration difference of two points, which are arranged in succession along the length of the concentration gradient and represent different volume elements, is ≥5%, more preferably ≥10%, still more preferably ≥15%, even considerably more preferably ≥20%, based on the higher concentration value in each case. This preferably applies to all adjacent concentration points of a concentration gradient. Particularly preferably, in this case, the concentration gradient has one of the lengths L_{K} defined above in relation to the component extension B_{E} and/or to the functional region extension FB_{E} and/or one of the aforementioned profiles. Preferably, none of the concentration points forming the gradients is arranged within the optional fiber material.

Preferably, the concentration gradient is arranged completely within the functional region and particularly preferably corresponds to the concentration gradient of the functional region extension FB_{E}.

In a preferred embodiment of the invention, the profile of the concentration values of the concentration gradient has at least two differently designed partial regions. For example, the profile of the concentration values of the concentration gradient can first decrease linearly and then increase stepwise. Complex concentration profiles can thereby be realized in the composite component. Preferably, the concentration gradient has partial regions of different inclination.

In a preferred embodiment of the invention, the concentration gradient has a point of highest concentration Cₘₐₓ and a point of lowest concentration Cₘᵢₙ, where Cₘₐₓ/Cₘᵢₙ≥2, preferably ≥5, still more preferably ≥10, even considerably more preferably ≥20 and most preferably ≥30. A high local difference in the development of the material property caused or influenced by the additive in the functional layer can be achieved by a correspondingly steep gradient of the concentration values.

Particularly preferred is an embodiment in which the point of highest concentration Cₘₐₓ and the point of lowest concentration Cₘᵢₙ of the concentration gradient have a minimum distance L_{Cmax->min}, where L_{Cmax->min}≥0.05*B_{E}, preferably L_{Cmax->min}≥0.2*B_{E}, more preferably L_{Cmax->min}≥0.3*B_{E}, more preferably L_{Cmax->min}≥0.4*B_{E}, still more preferably L_{Cmax->min}≥0.5*B_{E}.

For other applications, however, it can also be advantageous that, although a gradient exists in the functional region, the local concentration differences are limited. In another preferred embodiment of the invention, Cₘₐₓ/Cₘᵢₙ is therefore ≤2, preferably ≤5, still more preferably ≤10, even considerably more preferably ≤20 and most preferably ≤30.

In a preferred embodiment of the invention, Cₘₐₓ/Cₘᵢₙ is in a range between 1.5-50, preferably 3-30, still more preferably 5-25, even considerably more preferably 5-20, and most preferably 7-15.

In the preferred embodiments described above, the composite component particularly preferably has a maximum component extension B_{E} which is defined by the maximum distance between two points of the component, and the concentration gradient preferably has a length L_{K} where L_{K}≥0.05*B_{E}, preferably L_{K}≥0.2*B_{E}, more preferably L_{K}≥0.3*B_{E}, more preferably L_{K}≥0.4*B_{E}, still more preferably L_{K}≥0.6*B_{E} and most preferably is L_{K}≥0.75*B_{E}.

Preferably, the concentration gradient is designed such that an increased additive concentration is present on one of, a plurality of or all of the surfaces of the composite component and decreases toward the interior or vice versa.

In a preferred embodiment of the invention the concentration gradient therefore runs at least partially parallel to or in extension to an orthogonal projection of one of the outer surfaces of the functional region; particularly preferably in this case, the concentration of the additive increases at least partially, preferably continuously, toward one of the outer surfaces. Within the meaning according to the invention, an orthogonal projection is an image of a point on a plane which forms one of the outer surfaces of the composite component, so that the connecting line between the point and its image forms a right angle with this plane. The image then has the shortest distance to the starting point of all points of the plane.

The concentration gradient is preferably designed such that the point of the highest concentration of the gradient Cₘₐₓ is arranged on or in the immediate vicinity, i.e., in a spacing of no more than 0.1*B_{E} from all points of the closest outer surface. “Outer surface” is understood to mean a surface which does not adjoin a further region of the composite component and thus delimits the composite component toward the outside. In a preferred embodiment of the invention, the functional region has two or more concentration gradients, wherein the two or more concentration gradients are preferably designed such that the concentration of the additive increases toward the same outer surface.

Because the additive often serves to control a material property which is in a particular functional relationship with the outer surfaces, such an arrangement is particularly preferred. For example, the additive can serve to improve the impact resistance and, therefore, is particularly preferably accumulated at or near one of the outer surfaces. This embodiment is particularly preferable in particular also when the additive is to be subjected to further thermal treatment, such as carbonization, after introduction into the composite component.

In another preferred embodiment, the concentration gradient is designed such that the point of the highest concentration is arranged centrally in the component, i.e., at a distance ≥0.1*B_{E}, preferably ≥0.2*B_{E}, from the closest or all outer surfaces. In the case of a block-shaped or cuboid design of the component, the above spacing is preferably present relative to two or more outer surfaces.

In a preferred embodiment of the invention, the functional region is a fire protection region and has, for this purpose, a flame retardant as an additive which reduces the combustibility of the functional layer.

In this case, the flame retardant is particularly preferably selected from the group consisting of halogenated and/or nitrogen-based flame retardants, inorganic flame retardants, such as graphite salts, aluminum trihydroxide, antimony trioxide, ammonium polyphosphate, aluminum diethylphosphinate, mica, muscovite, guanidines, triazines, sulfates, borates, cyanurates, salts thereof, and mixtures thereof.

In other preferred embodiments, the additive is selected from the group consisting of antioxidants, light stabilizers, in particular UV stabilizers, plasticizers, foaming agents, electrical conductors, heat conductors, dyes, fillers for improving the mechanical properties, such as impact modifiers, or rubber or thermoplastic particles, and mixtures of the aforementioned.

The additive can be present in dissolved or dispersed form in the matrix material. If it is dispersed, it is preferably contained in the form of a powder, flakes, tubes or mixtures of the aforementioned forms.

If the additive is a flame retardant, it is preferably selected from the group of active, i.e., cooling, flame retardants or from the group of passive, i.e., insulating, flame retardants. Particularly preferably, the flame retardant is an intumescent flame retardant.

Like the optional other regions, the functional region can have further additives. In particular, the functional region can have a plurality of different additives which have different, preferably continuous, concentration gradients.

In a preferred embodiment of the invention, the matrix material contains or is a polymeric matrix material, which particularly preferably has one or more thermosets. Preferably, the matrix material is a polymeric matrix material selected from the group consisting of polyurethane, polyvinyl chloride, in particular polyvinyl chloride rigid foam, and phenolic and epoxy resins.

In a preferred embodiment of the invention, the fiber material has at least partially, preferably completely, a surface structure, preferably a textile surface structure.

Particularly preferably, the surface structure is selected from the group consisting of laid scrim, knitted fabric, woven fabric, braided fabric, nonwoven fabric or mixtures thereof.

According to the invention, nonwoven is understood to mean a structure of fibers of limited length, continuous fibers (filaments) or cut yarns of any type and any origin, which are joined in some way to form a fiber layer and have been connected to one another in some way. Excluded from this is the crossing or intertwining of yarns, as occurs in weaving, knitting, machine-knitting, lace weaving, braiding and production of tufted products. This definition corresponds to the standard DIN EN ISO 9092. According to the invention, the term nonwoven fabric also covers felt materials. However, films and papers do not belong to the nonwoven fabrics.

In the context of the invention, braiding is understood to mean the regular interleaving of a plurality of strands made of flexible material. The difference from weaving is that, during braiding, the threads are not supplied at a right angle to the main direction of production of the product.

According to the invention, woven fabric is understood to mean a textile fabric consisting of two thread systems, warp (warp threads) and weft (weft threads), which, in view of the fabric surface, intersect at an angle of exactly or approximately 90° in the form of a pattern. Each of the two systems can be constructed from a plurality of warp or weft types (e.g., basic, pile and filling warp; base, binding and filling weft). The warp threads run in the longitudinal direction of the woven fabric, parallel to the selvage, and the weft threads in the transverse direction, parallel to the fabric edge. The threads are connected to the woven fabric predominantly by frictional engagement. In order for a woven fabric to be sufficiently non-slip, the warp and weft threads must usually be woven relatively tightly. Therefore, apart from a few exceptions, the woven fabrics also have a closed fabric appearance. This definition corresponds to the standard DIN 61100, Part 1.

According to the invention, the terms woven fabric and nonwoven also include textile materials that have been tufted. Tufting is a method in which yarns are anchored into a woven fabric or a nonwoven with a machine operated by compressed air and/or electricity.

According to the invention, knitted fabrics are understood to mean textile materials which are produced from thread systems by knitting. These include both crocheted and knitted materials.

According to the invention, a laid scrim is understood to mean a fabric consisting of one or more layers of stretched threads running in parallel. The threads are usually fixed at the crossover points. The fixing takes place either by material bonding or mechanically by friction and/or positive locking. The laid scrim is preferably selected from a monoaxial or unidirectional, biaxial or multiaxial scrim.

Preferably, the fiber material has an anisotropic structure, i.e., within the functional layer according to the invention, the fibers have a specific fiber orientation. Anisotropic mechanical behavior of the layered composite can thereby be produced.

The fiber material is preferably selected from the group consisting of glass fibers, carbon fibers, ceramic fibers, basalt fibers, boron fibers, steel fibers, polymer fibers such as synthetic fibers, in particular aramid fibers and nylon fibers, or natural fibers, in particular natural polymer fibers. Natural fibers are understood to mean fibers which originate from natural sources such as plants, animals or minerals and can be used directly without further chemical conversion reactions. Examples according to the invention are flax or hemp fibers, and also protein fibers or cotton. According to the invention, it is also possible to use regenerated fibers, i.e., fibers which are produced via chemical processes from naturally occurring, renewable raw materials.

In a preferred embodiment of the invention, all of the additive located in the composite component is present in the functional region, substantially, i.e., ≥70 wt. %, preferably ≥80 wt. %, even more preferably ≥90 wt. %, and most preferably completely, in a spatially delimited first subsection of the functional region. This first subsection preferably encloses at least one outer surface of the composite component at least partially, preferably completely. If the composite component has more than one functional region, the aforementioned proportion by weight and the volume fractions mentioned below preferably relate to one or more than one functional region.

In a preferred embodiment of the invention, the volume V_{T1} of the first subsection, in which the additive of the functional region is substantially located, makes up a considerable part of the total volume of the functional region V_{FB}. Preference is given to V_{T1}≥0.1*V_{FB}, more preferably V_{T1}≥0.3*V_{FB}, still more preferably V_{T1}≥0.5*V_{FB}, still more preferably V_{T1}≥0.7*V_{FB} and most preferably V_{T1}≥0.9*V_{FB}.

In a preferred embodiment of the invention, which is preferably combined with the above preferred embodiment, the functional region has a second subsection in which there is no additive. The volume V_{T2} of this second subsection is preferably V_{T2}≤0.7*V_{FB}, more preferably V_{T2}≤0.5*V_{FB}, more preferably V_{T2}≤0.3*V_{FB}, still more preferably V_{T2}≤0.2*V_{FB} and most preferably V_{T2}≤0.1*V_{FB}.

In another particularly preferred embodiment, all of the additive located in the composite component is arranged substantially, preferably completely, in the functional region.

In a preferred embodiment of the invention, the volume V_{T1} of the subsection in which the additive of the functional region is substantially located is low in relation to the total volume of the functional region V_{FB}. Preference is given to V_{T1}≤0.7*V_{FB}, more preferably V_{T1}≤0.5*V_{FB}, more preferably V_{T1}≤0.3*V_{FB}, still more preferably V_{T1}≤0.2*V_{FB} and most preferably V_{T1}≤0.1*V_{FB}.

In a preferred embodiment of the invention, which is preferably combined with the above preferred embodiment, the functional region has a second subsection in which there is no additive. The volume V_{T2} of this second subsection is preferably V_{T2}≥0.1*V_{FB}, more preferably V_{T2}≥0.2*V_{FB}, more preferably V_{T2}≥0.3*V_{FB}, still more preferably V_{T2}≥0.5*V_{FB} and most preferably V_{T2}≥0.7*V_{FB}.

Preferably, the volume of the functional region forms more than 50% of the volume of the composite component, more preferably more than 65%, still more preferably more than 75%, even considerably more preferably more than 90% and most preferably more than 95% or even 100%. For these cases, the composite component is particularly preferably designed in one piece, preferably cured in one piece.

In a preferred embodiment of the invention, the volume V_{T1} of the first subsection, in which the additive of the functional region is substantially located, makes up a considerable part of the total volume of the composite component V_{KB}. Preference is given to V_{T1}≥0.1*V_{KB}, more preferably V_{T1}≥0.3*V_{KB}, still more preferably V_{T1}≥0.5*V_{KB}, still more preferably V_{T1}≥0.7*V_{KB} and most preferably V_{T1}≥0.9*V_{KB}.

In a preferred embodiment of the invention, which is preferably combined with the above preferred embodiment, the functional region has a second subsection in which there is no additive. The volume V_{T2} of this second subsection is preferably V_{T2}≤0.7*V_{KB}, more preferably V_{T2}≤0.5*V_{KB}, more preferably V_{T2}≤0.3*V_{KB}, still more preferably V_{T2}≤0.2*V_{KB} and most preferably V_{T2}≤0.1*V_{KB}.

In a preferred embodiment of the invention, the volume V_{T1} of the subsection in which the additive of the functional region is substantially located is low in relation to the total volume of the composite component V_{KB}. Preference is given to V_{T1}≤0.7*V_{KB}, more preferably V_{T1}≤0.5*V_{KB}, more preferably V_{T1}≤0.3*V_{KB}, still more preferably V_{T1}≤0.2*V_{KB} and most preferably V_{T1}≤0.1*V_{KB}.

In a preferred embodiment of the invention, which is preferably combined with the above preferred embodiment, the functional region has a second subsection in which there is no additive. The volume V_{T2} of this second subsection is preferably V_{T2}≥0.1*V_{KB}, more preferably V_{T2}≥0.2*V_{KB}, more preferably V_{T2}≥0.3*V_{KB}, still more preferably V_{T2}≥0.5*V_{KB} and most preferably V_{T2}≥0.7*V_{KB}.

Preferably, the volume of the functional region forms more than 50% of the volume of the composite component, more preferably more than 65%, still more preferably more than 75%, even considerably more preferably more than 90%, and most preferably more than 95%. For this case, the composite component is particularly preferably designed in one piece, preferably cured in one piece.

In a particularly preferred embodiment, the functional region has only volume portions with additive, i.e., V_{T1}=V_{FB}, and/or the composite component consists of the functional region, i.e., V_{FB}=V_{KB}.

Particularly preferably, the additive is present at ≥70 wt. %, preferably ≥80 wt. %, still more preferably ≥90 wt. %, still more preferably ≥95 wt. % and most preferably completely in the volume V_{FB}.

The composite component according to the invention is preferably a motor vehicle component, a building component, a composite part for an aircraft or spacecraft or a rail vehicle or a part of the aforementioned.

In a preferred embodiment, the motor vehicle component which is formed by the composite component, or of which the composite component is a part, is a component of a battery housing, particularly preferably the base or cover plate. Further preferred motor vehicle components are selected from the group consisting of trunk cargo floors, instrument panels, door and roof claddings, underbody protection parts, structural components, wheel housings, engine compartment parts, brake and clutch linings and disks, acoustic insulation, shear panels, and seals.

In a further preferred embodiment of the invention, the composite component is a part of an aircraft or spacecraft, such as an airplane. Preferred parts in this context are tail rotor blades, main rotor hub plates, engine components, tanks, body structures, fire protection elements, such as fire protection layers, rotating parts, turbine blades, and wings.

In a further preferred embodiment of the invention, the composite component is a building component, for example for a wind turbine. In this context, preferred parts are rotor blades for wind turbines, in particular the structure and outer skin parts of the “nacelle,” lines, and tubes, walls and roofs.

The invention also relates to a method for producing one of the aforementioned composite components, comprising the following steps:
I) providing a composition for forming a composite component in a shaping tool, such as a press mold, comprising or consisting of
   a) a fiber material,
   b) one or more precursor compounds for a matrix material,
   c) an additive, preferably a flame retardant,
II) exerting a predetermined pressure, preferably by pressing, and a predetermined temperature on the composition in order to obtain the composite component.

Step I) preferably comprises one, more or all of the following sub-steps:
a) providing one or more layers of a fiber material in a forming tool, for example by a hand-laying process,
b) providing one or more precursor compounds for a matrix material,
c) providing one or more additives, preferably dissolved in the one or more precursor compounds,
d) bringing the one or more precursor compounds for a matrix material in contact with the fiber material, preferably by spraying,
e) at least partial reaction of the one or more precursor compounds, such as a system of resin, hardener, and an optional release agent in order to obtain a matrix material (=curing).

In the method according to the invention, the additive can generally be introduced into the functional region, by the following method measures:
i) the fibrous material used can be provided with the additive, for example by applying a solution of the additive or applying an additive powder which can optionally be provided with a binder for better adhesion to the fiber material,
ii) the additive is preferably introduced into the one or more precursor compounds in dissolved and/or dispersed form,
iii) the additive is introduced into a shaping tool that is unfilled, or is filled partially or completely with the one or more precursor compounds.

The local modification of the material properties by varying additive distribution in the matrix material can be produced by way of example by
i) different local accumulation of the additive on the fibrous material or on a prepreg which is introduced into the shaping tool,
ii) varying the concentration of the additive present in dissolved and/or dispersed form in the one or more precursor compounds during introduction into the shaping tool,
iii) the additive is introduced locally gradually into the at least partially filled shaping tool before, during or after the reaction of the one or more precursor compounds.

The predetermined pressure in step II) of the method defined in claim 15 is preferably in a range from 1 bar to 1000 bar, particularly preferably from 5 bar to 500 bar, still more preferably from 10 bar to 100 bar, and most preferably from 20 to 50 bar.

The predetermined temperature in step II) of the method defined in claim 15 is preferably in a range from 10° C. to 900° C., particularly preferably from 15° C. to 700° C., still more preferably from 20° C. to 500° C., and most preferably from 25° C. to 200° C.

Particularly preferably, the method for producing the composite component according to the invention is a wet pressing method. In such a method, liquid reaction resins are processed as precursor compounds together with reinforcing fibers in two-part molds. The upper mold part and lower mold part are closed by means of a press.

In the wet pressing process, the resin is usually poured onto the fiber mats centrally or following a fixed pouring schedule. In this step, the additive can be added at different points in time with a preferably varying concentration.

In most cases, polyurethane, epoxy resin or polyamide systems are used which are formed from two or more precursor compounds that are mixed in a special mixing head to form a reactive liquid plastics material. A flat sheet die or other distributor systems are preferably used for flat application on the fiber mats.

The fiber mats are preferably laid as fiber carpets. Such a method is characterized by a particularly high efficiency.

The plastic is distributed within the entire mold by the closing process of the tool under the pressure of the press and wets the reinforcing fibers. At the same time or thereafter, the plastic/resin is cured—usually at elevated temperature. If the plastic is cured, this provides the dimensional stability of the component, which can be demolded after the tool has been opened.

The additive is preferably introduced into the functional layer by admixture into one or more of the precursor compounds for the matrix material. By varying the additive proportion, a concentration gradient can thereby be generated when the matrix material is fed into the shaping tool.

In the methods for producing the composite components according to the invention, the fiber mats can be pre-formed to form a so-called preform, in particular when there is increased geometric complexity.

The invention also relates to the use of a composite component as defined in the claims and in the preceding sections as a motor vehicle component, building component, composite part for an aircraft or spacecraft, rail vehicle component or a part of the aforementioned.

Particularly preferred is the use as part of a battery housing, in particular for a lithium-ion battery.

The invention also relates to the use of a concentration gradient of an additive in a composite component in order to obtain locally varying material properties, in particular locally varying combustibility or locally varying shielding properties, of the composite component, wherein the composite component is preferably designed in one piece.

The invention also relates to the use of a concentration gradient of an additive, arranged within a matrix material, of a composite component in order to obtain locally varying material properties of the composite component.

### BRIEF DESCRIPTION OF FIGURES

The present invention is explained in more detail below with reference to the exemplary embodiments indicated in the figures.

FIG. 1 shows a composite component 1, which is formed in one piece and consists of a functional region which comprises a fiber material, a matrix material and an additive. The fiber material is represented graphically by horizontal lines. To simplify the illustration, the fiber material embedded in the matrix material is not shown explicitly. The concentration of the added additive, such as a flame retardant additive, increases continuously in the direction of the arrow. This is represented by an increasing shading of the composite component.

FIG. 2 shows a composite component 1 which is formed in several pieces, wherein the additive-containing layers 2, 3 and 4 each have different, but constant concentrations within the layer. The concentration of the additive is higher in layer 2 than in layer 3, which in turn has a higher concentration of the additive than layer 4. This results in a higher concentration of the additive toward the upper outer surface of the composite component and thus an increased development of the property caused or influenced by the additive.

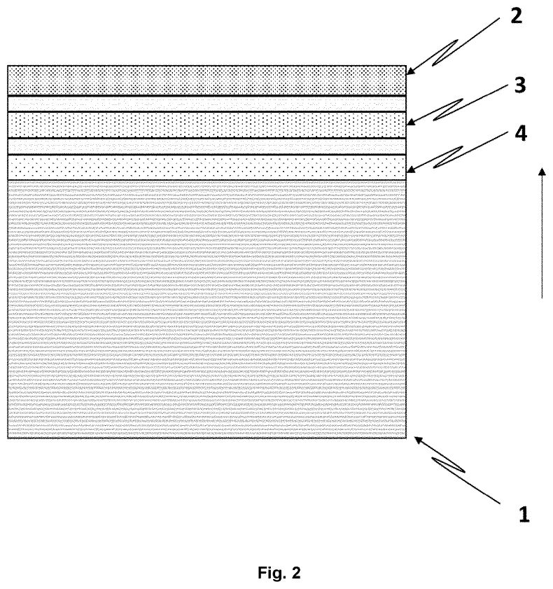

FIG. 3 shows a composite component 1 in which the additive is arranged in a subsection of the functional region.

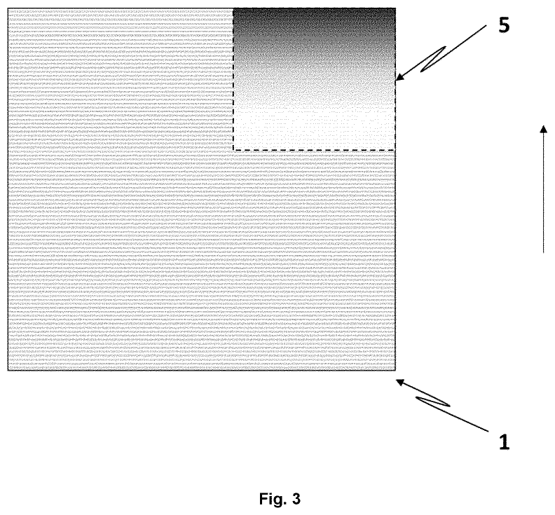

FIG. 4 shows a composite component 1 in which two different additives are arranged in two different subsections.

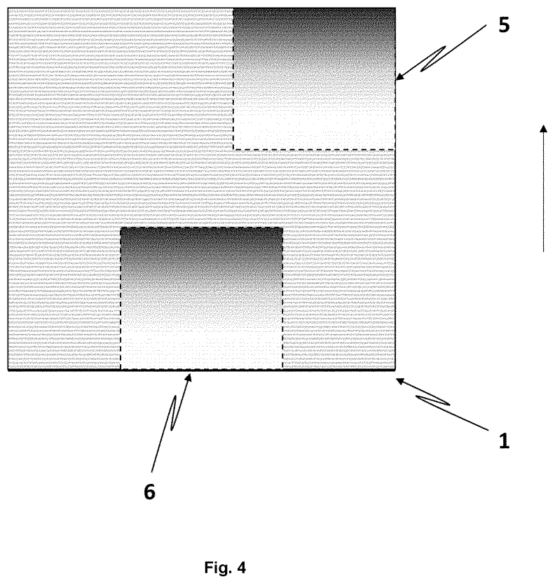

### DETAILED DESCRIPTION

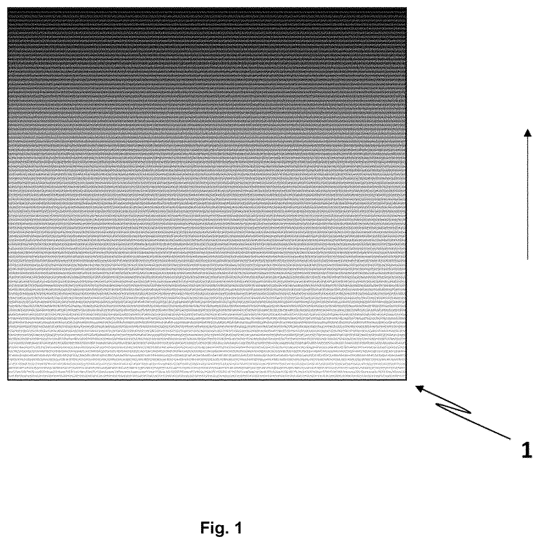

FIG. 1 shows schematically and by way of example a composite component according to the invention, as it can be used, for example, for a cover or base of a battery housing for an electric vehicle. Depending on the arrangement of the battery cells in the housing, specific regions of the cover are exposed to particularly high temperatures in the event of a battery fire, and particularly high concentrations of fire retardant additives are necessary in these portions of the cover.

To produce such a composite component, several layers of carbon fiber multiaxial fabric are cut to the size of the cover or base to be produced and stacked on top of each other. The total grammage of the textiles as well as the distribution of the proportions of different fiber directions (e.g., below 0°, + and −45° and 90° in relation to the vehicle's longitudinal axis) are determined during the design process according to the mechanical and other stress on the cover. In a simple basic structure, the proportions of the direction of travel in 0°, −45°, 45° and 90° are equal, so that a so-called quasi-isotropic laminate is created.

A resin-hardener mixture of an epoxy resin is distributed evenly across the stack of layers. In the regions subject to particularly high temperatures, e.g., in the middle of the later component, a high concentration of fire protection additive such as aluminum hydroxide is mixed into the resin, whereas in the less stressed edge regions only a low concentration is added. This creates a concentration gradient of the additive. The layer stack is now placed in a press and compressed between two mold halves that have the geometry of the later component. The resin—including additive in the middle region—is pressed into the layer stack and the reinforcing fibers are embedded in the resin-additive mixture. Sufficient press closing force ensures that the layer stack is compressed to the correct component thickness. An increased temperature of the mold halves accelerates the reaction of resin and hardener components of the epoxy resin, so that it reacts to form the matrix material in a short time.

The component is then removed from the mold and fed to the final processing steps.

### REFERENCE SIGNS

1 Composite component
2 Layer with an additive concentration Cₐ
3 Layer with an additive concentration C_{b}
4 Layer with an additive concentration C_{c}
5 First subsection with first additive
6 Second subsection with second additive

1-17. (canceled)

18. A composite component comprising:
a) a fiber material,
b) a matrix material, and
c) a functional region with an additive arranged therein which causes or influences a material property, in particular an optical, thermal, mechanical and/or electromagnetic material property, in the functional region,
wherein the functional region has a concentration gradient of the additive, so that the material property caused or influenced by the additive is pronounced to varying degrees in the functional region.

19. The composite component according to claim 18, wherein the concentration gradient is designed such that the concentration of the additive increases at least partially, preferably completely, in the direction of one of the outer surfaces of the functional region and/or the composite component.

20. The composite component according to claim 18, wherein the concentration values of the concentration gradient along its spatial profile continuously rise or fall at least in sections, preferably completely.

21. The composite component according to claim 18, wherein the concentration gradient has at least two portions in which it has different profiles of the concentration values.

22. The composite component according to claim 18, wherein the concentration gradient is designed such that it comprises a point of highest concentration Cₘₐₓ and a point of lowest concentration Cₘᵢₙ where Cₘₐₓ/Cₘᵢₙ≥5, preferably ≥10.

23. The composite component according to claim 18, wherein the concentration gradient runs at least partially parallel or in extension to an orthogonal projection of one of the outer surfaces of the functional region and/or the composite component.

24. The composite component according to claim 18, wherein the functional region is a fire protection region, the additive is a flame retardant, and the material property which is caused or influenced by the additive is combustibility.

25. The composite component according to claim 24, wherein the flame retardant is selected from the group consisting of halogenated and/or nitrogen-based flame retardants, inorganic flame retardants such as graphite salts, aluminum trihydroxide, antimony trioxide, ammonium polyphosphate, aluminum diethylphosphinate, mica, muscovite or mixtures thereof.

26. The composite component according to claim 18, wherein the additive is dispersed in the matrix material, preferably in the form of a powder, in the form of flakes, tubes or mixtures of the aforementioned forms.

27. The composite component according to claim 18, wherein the matrix material contains or is a polymeric matrix material, particularly preferably a thermoset.

28. The composite component according to claim 18, wherein the fiber material has, at least partially, preferably completely, a preferably textile surface structure which is selected from the group consisting of laid scrim, woven fabric, nonwoven fabric or mixtures thereof, wherein the fiber material is preferably selected from glass fibers, carbon fibers, basalt fibers, ceramic fibers, steel fibers, polymer fibers, such as synthetic fibers, in particular aramid and nylon fibers, or natural polymer fibers, such as flax, hemp, or protein fibers.

29. The composite component according to claim 18, wherein the functional region encloses at least one outer surface of the composite component at least in sections.

30. The composite component according to claim 18, wherein the composite component is designed in one piece and/or the functional region makes up ≥30%, preferably ≥50%, of the volume of the composite component.

31. A motor vehicle component or a building component comprising a composite component according to claim 18, wherein the motor vehicle component is preferably a component of a battery housing, particularly preferably the base or cover plate.

32. A method for producing a composite component according to claim 18 comprising the following steps:
I) providing a composition for forming a composite component in a shaping tool, such as a press mold, comprising or consisting of
a) a fiber material,
b) a precursor compound for a matrix material, and
c) an additive, preferably a flame retardant,
II) exerting a predetermined pressure and a predetermined temperature on the composition in order to obtain the composite component.

33. The method according to claim 32, wherein the method is a wet pressing method.

34. A use of a composite component according to claim 18 as or in a motor vehicle component, preferably as part of a battery housing.
